(19) United States
(12) Patent Application Publication
(10) Pub. No.: US 2021/0244974 A1
(43) Pub. Date: Aug. 12, 2021

(54) VEHICLE DOOR GLASS BREAKING DEVICE

(71) Applicant: TOYOTA JIDOSHA KABUSHIKI KAISHA, Aichi-ken (JP)

(72) Inventor: Yoshinori UOZUMI, Toyota-shi (JP)

(21) Appl. No.: 17/137,231

(22) Filed: Dec. 29, 2020

(30) Foreign Application Priority Data
Feb. 10, 2020 (JP) 2020-020948

(51) Int. Cl. A62B 3/00

(52) U.S. Cl. CPC A62B 3/005

(57) ABSTRACT

A vehicle door glass breaking device includes a breaking portion including a pointed end portion configured to point towards an inner surface of a door glass; a guide portion configured to be disposed at the inner surface of the door glass, and guiding the breaking portion in a thickness direction of the door glass; and a restricting portion configured, in a case in which a pressing force, applied by a vehicle occupant to another end portion of the breaking portion, at an opposite side of the breaking portion from the pointed end portion, in a direction towards a side of the door glass, is equal to or greater than a predetermined magnitude, to permit displacement of the breaking portion towards the door glass, and in a case in which the pressing force is smaller than the predetermined magnitude, to restrict displacement of the breaking portion towards the door glass.

### CROSS-REFERENCE TO RELATED APPLICATION

This application claims priority under 35 USC 119 from Japanese Patent Application No. 2020-20948 filed on Feb. 10, 2020, the disclosure of which is incorporated by reference herein in its entirety.

### BACKGROUND

### Technical Field

The present disclosure relates to a vehicle door glass breaking device.

### Related Art

An invention relating to a vehicle door glass breaking device is disclosed in Japanese Patent Application Laid-Open (JP-A) No. 2012-245952. In this vehicle door glass breaking device, a breaking rod is disposed in a vehicle door such that a pointed distal end thereof points towards a door glass surface. This breaking rod is linked via a linking mechanism to an operating lever that is provided at a vehicle inner side of the vehicle door. Because of this, in an emergency, by operating this operating lever, a vehicle occupant is able to move the breaking rod and break the door glass.

### SUMMARY

However, in the aforementioned publication, the operating lever and the breaking rod are linked together via a linking mechanism, and the direction of input of the operating force by a vehicle occupant is the opposite direction from the direction in which the breaking rod pierces the door glass.

Because of this, there is room for improvement regarding transmitting the input by the vehicle occupant directly to the door glass in an emergency, and thereby ensuring the probability that the door glass will be broken.

The present disclosure was conceived in view of the above-described circumstances, and it is an object of the present disclosure to provide a vehicle door glass breaking device that enables an input by a vehicle occupant to be transmitted directly to door glass in an emergency, and thereby ensure the probability that the door glass will be broken.

A vehicle door glass breaking device of a first aspect of the present disclosure includes a breaking portion including a pointed end portion that is configured to point towards a surface at a vehicle inner side of door glass that is manufactured from tempered glass, a guide portion configured to be disposed at the surface at the vehicle inner side of the door grass and being configured to guide the breaking portion in a thickness direction of the door glass, and a restricting portion configured, in a case in which a pressing force applied by a vehicle occupant to another end portion of the breaking portion, at an opposite side of the breaking portion from the pointed end portion, in a direction from a side of the other end portion towards a side of the door glass, is equal to or greater than a predetermined magnitude, to permit displacement of the breaking portion towards the side of the door glass, and in a case in which the pressing force is smaller than the predetermined magnitude, to restrict displacement of the breaking portion towards the side of the door glass.

According to the first aspect, a vehicle door glass breaking device is provided with a breaking portion having a pointed end portion. The pointed end portion is configured to point towards a surface at a vehicle inner side of a door glass that is manufactured from tempered glass. In an emergency, by moving the breaking portion towards the door glass and causing the pointed end portion of the breaking portion to pierce the door glass, it is possible to break the door glass.

In a structure in which a direction of input of the operating force when a vehicle occupant operates the breaking portion is the reverse direction from a direction in which the breaking portion pierces the door glass, there may be instances in which the transmission path of this operating force becomes more complex before the operating force is transmitted to the door glass.

In the first aspect, a guide portion and a restricting portion are provided. The guide portion is disposed at the surface at the vehicle inner side of the door glass and is configured to guide the breaking portion in the thickness direction of the door glass. The restricting portion permits displacement of the breaking portion towards a side of the door glass in a case in which the pressing force that is applied by the vehicle occupant to the other end portion of the breaking portion in a direction from a side of the other end portion towards a side of the door glass is equal to or greater than a predetermined magnitude.

In an emergency, by pressing the breaking portion from the side of the other end portion using a pressing force that is equal to or greater than a predetermined magnitude, a vehicle occupant is able to move the breaking portion towards the door glass and consequently cause the breaking portion to pierce the door glass. The direction of input of the operating force by the vehicle occupant is the same direction as the direction in which the breaking portion pierces the door glass, and it is possible to simplify the transmission path of this operating force towards the door glass.

In a case in which the pressing force that is applied by the vehicle occupant from the side of the other end portion of the breaking portion towards the side of the door glass is less than the predetermined magnitude, the restricting portion restricts movement of the breaking portion towards the side of the door glass. When there is no emergency, it is possible to inhibit the breaking portion from being displaced towards the side of the door glass due to a miss-operation performed by a vehicle occupant.

A vehicle door glass breaking device of a second aspect of the present disclosure, in the first aspect, the breaking portion is formed from metal, and the vehicle door glass breaking device further includes a pressed portion. The pressed portion is provided at the other end portion of the breaking portion, and is formed in a plate shape so as to cover the other end portion of the breaking portion when viewed from the thickness direction of the door glass.

According to the second aspect, the breaking portion is formed from metal. Accordingly, when the point end portion of this breaking portion comes into contact with the door glass, it is possible to inhibit the point end portion from being deformed and the pressing force applied by the vehicle occupant to the breaking portion from being absorbed by the deformation.

Moreover, in the second aspect, the pressed portion is provided at the other end portion of the breaking portion, and a vehicle occupant presses the breaking portion towards the door glass via the pressed portion. Because the pressed portion is formed in a plate shape that covers the other end portion of the breaking portion when viewed from the thickness direction of the door glass, compared with a structure in which a vehicle occupant directly presses the breaking portion, it is possible to secure a wider surface area at which a vehicle occupant is able to press.

A vehicle door glass breaking device of a third aspect of the present disclosure, in the second aspect, the restricting portion has an urging component that urges the pressed portion with a load of the predetermined magnitude from a side of the pointed end portion towards the side of the other end portion of the breaking portion, and supporting portions that are provided at the guide portion, and the supporting portions are able to support the pressed portion in a case in which the pressed portion is urged by the urging component.

According to the third aspect, the restricting portion is provided with an urging component and supporting portions. The urging component urges the pressed portion with a load of the predetermined magnitude from the side of the pointed end portion towards the side of the other end portion of the breaking portion. The supporting portions are provided at the guide portion and are able to support the pressed portion in a case in which the pressed portions are urged by the urging component. Because of this, when a vehicle occupant does not press the pressed portion, the pressed portion is pressed against the supporting portions by the urging component, and is placed in a state in which displacement of the pressed portion in the thickness direction of the door glass is restricted.

In contrast, when the pressed portion is pressed by a vehicle occupant towards the side of the door glass with a pressing force of the predetermined magnitude or greater, although the pressed portion is displaced towards the side of the door glass, once the pressed portion is released from being pressed by the vehicle occupant, the pressed portion is displaced towards a side of the supporting portions by urging force from the urging component. As a result, the breaking portion can be pressed repeatedly against the door glass.

A vehicle door glass breaking device of a fourth aspect of the present disclosure, in any one of the first through third aspects, the guide portion is formed in a cylindrical shape, the guide portion is configured to accommodate the breaking portion inside of the guide portion, and the vehicle door glass breaking device further includes a lid portion that is configured to open and close an end portion of the guide portion at an opposite side of the guide portion from the door glass.

According to the fourth aspect, the guide portion is formed in the shape of a cylinder, and the breaking portion is accommodated inside the guide portion. An end portion at an opposite side of the guide portion from a side of the door glass can be opened or closed by a lid portion. At normal times, the breaking portion can be placed in a state in which an operation thereof by a vehicle occupant is inhibited, and during emergencies, the vehicle occupant releases the state in which the guide portion is closed off by the lid, so that the breaking portion is able to be operated by the vehicle occupant.

A vehicle door glass breaking device of a fifth aspect of the present disclosure, in the invention of any one of the first through fourth aspects, the guide portion is joined by an adhesive agent to the inner surface of the door glass via a coating portion that is formed by a ceramic print and that is coated on the inner surface of the door glass, and the coating portion covers a joint region between the guide portion and the door glass when viewed from a vehicle outer side.

According to the fifth aspect, the guide portion is joined by an adhesive agent to a join portion at the inner surface of the door glass.

In a case in which there is no portion to cover the joint portion from the vehicle outer side of the joint portion, it is difficult to secure an attractive appearance when the periphery of the guide portion is viewed from outside the vehicle. Moreover, if sunlight transmitted through the door glass strikes the joint portion, there is a possibility of the joint portion deteriorating. Providing a coating film using paint between the joint portion and the door glass may be considered in order to prevent the deterioration, however, if the adhesion between the coating film and the door glass is inadequate, there is a possibility that a portion of the coating film that is in contact with the joint portion may be peeled away from the door glass due to external force acting on the guide portion.

In the fifth aspect, the coating portion in the form of a ceramic print is interposed between the joint portion and the inner surface of the door glass, and the coating portion is disposed so as to cover the joint portion when viewed from the outside of the vehicle. It is possible for the joint portion to be concealed by the coating portion when viewed from outside the vehicle, and it is also possible to inhibit sunlight from directly striking the joint portion.

Moreover, because the coating portion is formed by performing a heat treatment so as to bake a ceramic coating material onto the door glass, even if external force is applied to the coating portion from a side of the joint portion, it is possible to inhibit the coating portion from peeling away from the door glass.

As has been described above, the vehicle door glass breaking device of the first aspect has the excellent effect that, in an emergency, input by a vehicle occupant is transmitted directly to door glass so as to ensure the probability that the door glass will be broken.

The vehicle door glass breaking device of the second aspect has the excellent effect that breaking the door glass by the vehicle occupant is performed well.

The vehicle door glass breaking device of the third aspect has the excellent effect that, in an emergency, it is possible to increase the probability that the door glass will be broken.

The vehicle door glass breaking device of the fourth aspect has the excellent effect that it is possible to inhibit a miss-operation of the device from being performed by a vehicle occupant.

The vehicle door glass breaking device of the fifth aspect has the excellent effect that it is possible to inhibit the coating film on the door glass from peeling away because of deterioration caused by sunlight or because of external force, at the same time as a favorable external appearance of the vehicle is ensured.

### BRIEF DESCRIPTION OF THE DRAWINGS

Preferred embodiments will be described in detail based on the following figures, wherein:

FIG. 1 is a partial cross-sectional view schematically showing a structure of a vehicle door glass breaking device according to a first exemplary embodiment, and shows a state sectioned by a line 1-1 shown in FIG. 2;

FIG. 2 is a front view schematically showing the structure of the vehicle door glass breaking device according to the first exemplary embodiment;

FIG. 3 is a partial cross-sectional view schematically showing a state when the vehicle door glass breaking device according to the first exemplary embodiment is assembled, and is a partial cross-sectional view corresponding to FIG. 1;

FIG. 4 is a schematic enlarged view showing a sticker that is adhered to the vehicle door glass breaking device according to the first exemplary embodiment;

FIG. 5 is a partial cross-sectional view schematically showing a state when the vehicle door glass breaking device according to the first exemplary embodiment is being used;

FIG. 6 is a front view showing a relationship between a sliding door and the vehicle door glass breaking device according to the first exemplary embodiment;

FIG. 7 is a side view schematically showing a structure of a vehicle provided with the vehicle door glass breaking device according to the first exemplary embodiment; and

FIG. 8 is a partial cross-sectional view schematically showing a structure of a vehicle door glass breaking device according to a second exemplary embodiment.

### DETAILED DESCRIPTION

### First Exemplary Embodiment

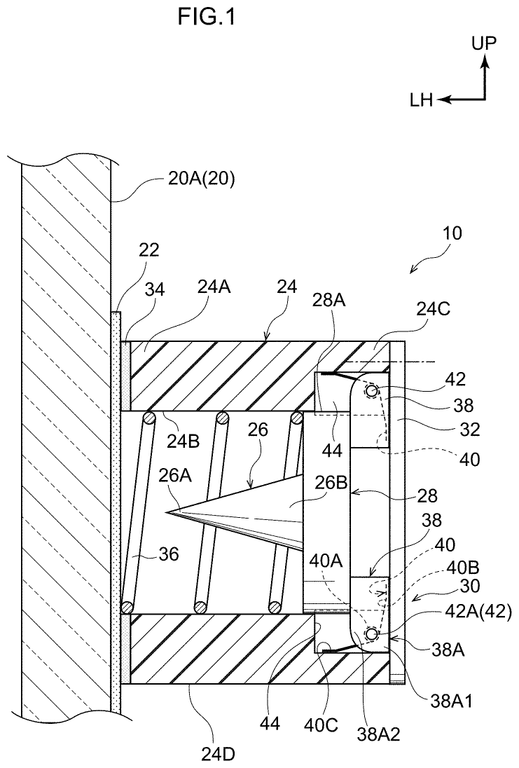

A vehicle door glass breaking device 10 (hereinafter, this will be abbreviated to a breaking device 10) according to a first exemplary embodiment of the present disclosure will now be described using FIG. 1 through FIG. 7. Note that an arrow FR, an arrow UP, and an arrow LH that are shown in the appropriate drawings respectively indicate a front side of a vehicle 12 in which the breaking device 10 is provided, a vehicle upward direction, and a left side in a vehicle width direction.

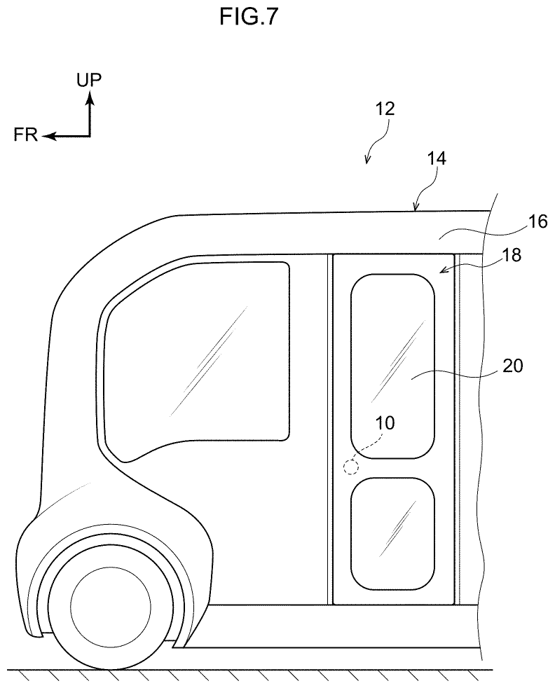

As is shown in FIG. 7, the vehicle 12 is provided with a vehicle body 14, and a door aperture portion (not shown in the drawings) is provided at a side portion 16 of the vehicle body 14. The door aperture portion is opened and closed by a sliding door 18 that is slidable in a vehicle front-rear direction relative to the vehicle body 14.

The sliding door 18 is formed so as to include a door glass 20, which is manufactured from tempered glass, and a door frame (not shown in the drawings) that supports the door glass 20. The door glass 20 is formed having a rectangular shape whose longitudinal direction extends in a vehicle up-down direction when viewed in a vehicle width direction, and is also formed having a planar shape whose thickness direction extends in the vehicle width direction.

In other words, in the present exemplary embodiment, an up-down direction of the door glass 20 coincides with the vehicle up-down direction, a width direction of the door glass 20 coincides with the vehicle front-rear direction, and a thickness direction of the door glass 20 coincides with the vehicle width direction. Note that hereinafter, unless specifically stated otherwise, the width direction of the door glass 20 is abbreviated to the ‘width direction’, the thickness direction of the door glass 20 is abbreviated to the ‘thickness direction’, and a height direction of the door glass 20 is abbreviated to the ‘height direction’.

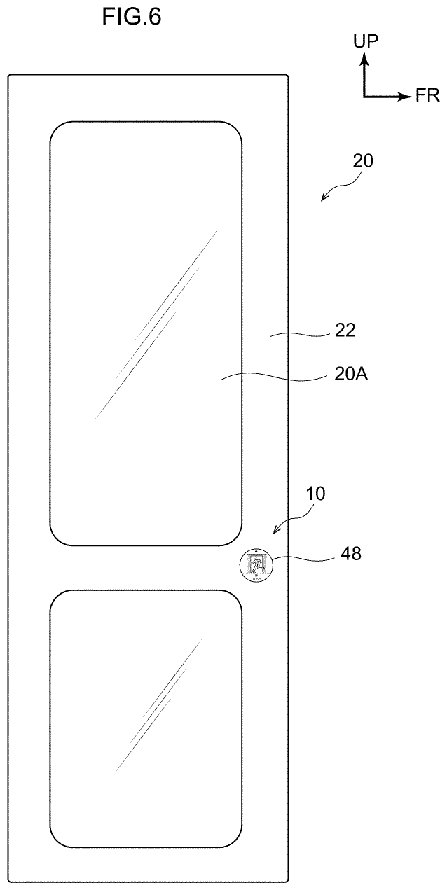

As is shown in FIG. 6, a ceramic print is made at an inner surface 20A at a vehicle inner side of the door glass 20 at circumferential edge portions and at a central portion in the up-down direction of the door glass 20 by performing heat treatment on a ceramic coating material so that this is baked onto the inner surface 20A. Note that, hereinafter, the coating film formed by the ceramic print provided on the inner surface 20A is referred to as a coating portion 22.

In the present exemplary embodiment, the breaking device 10 is disposed at a portion in a central area in the up-down direction and at one side (i.e., at the vehicle front side) in the width direction of the inner surface 20A of the door glass 20 where the coating portion 22 is provided. A structure of this breaking device 10 is described below in detail.

As is shown in FIG. 1, the breaking device 10 is provided with a guide portion 24, a breaking portion 26, a base plate portion 28 which serves as a pressed portion, a restricting portion 30, and a cover portion 32 which serves as a lid portion.

The guide portion 24 is made from resin in a circular cylinder shape, and is arranged so as to form a circle when viewed in the thickness direction. An end portion 24A on a first side in the thickness direction (i.e., on the outer side in the vehicle width direction) of this guide portion 24 is joined by a join portion 34 in the form of a urethane-based adhesive agent and via the coating portion 22 to the inner surface 20A of the door glass 20. In addition, parts of the coating portion 22 around a periphery of the guide portion 24 are disposed so as to cover the join portion 34 when viewed from outside the vehicle. The breaking portion 26, the base plate portion 28, and the restricting portion 30 are housed inside the guide portion 24,

The breaking portion 26 is made from a metal such as steel or the like, and is formed in the shape of a cone. The breaking portion 26 is disposed such that a pointed one end portion 26A thereof points towards the inner surface 20A of the door glass 20. The breaking portion 26 is able to break the door glass 20 in a case in which the one end portion 26A is made to pierce the door glass 20. The base plate portion 28, which is formed as a separate body from the breaking portion 26 is attached to another end portion 26B of the breaking portion 26.

The base plate portion 28 is made from resin in a circular plate shape, and covers the other end portion 26B of the breaking portion 26 when viewed in the thickness direction. More specifically, an outer circumferential surface portion 28A of the base plate portion 28 is placed so as to abut against an inner circumferential surface portion 24B of the guide portion 24, and is able to slide in the thickness direction at the inner side of the guide portion 24. As a result, in the present exemplary embodiment, the base plate portion 28 as well as the breaking portion 26 can be guided in the thickness direction by the guide portion 24.

The restricting portion 30 is formed so as to include a cylindrical coil spring 36, which serves as an urging component, and a pair of supporting portions 38 that are made from resin. The cylindrical coil spring 36 is disposed such that a direction of compression thereof extends in the thickness direction. When the breaking portion 26 is inserted inside the cylindrical coil spring 36, the cylindrical coil spring 36 urges the base plate portion 28 from a side of the one end portion 26A of the breaking portion 26 towards a side of the other end portion 26B thereof.

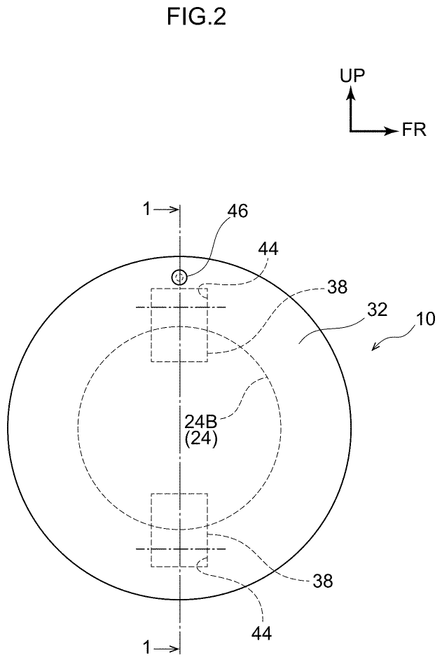

As is also shown in FIG. 2, two supporting portions 38 are disposed at a pitch of 180° when viewed in the thickness direction at an end portion 24C at a second side in the thickness direction of the guide portion 24. These supporting portions 38 are formed basically as rectangular parallelepipeds. An end portion 38A on one side in the longitudinal direction of each supporting portion 38 is attached in such a way as to be able to move rotationally relative to the guide portion 24, and is urged by a torsion coil spring 40.

More specifically, a penetration portion (not shown in the drawings) is formed in each end portion 38A, and a shaft portion 42 that is made from metal is engaged with the penetration portion in the vehicle front-rear direction. Both end portions 42A of the shaft portion 42 are exposed for a predetermined length from the supporting portions 38. When viewed in the longitudinal direction of the shaft portion 42 (i.e., in the vehicle front-rear direction), one corner portion 38A1 of the end portion 38 is formed as a right angle while another corner portion 38A2 thereof is formed in an arc shape.

Moreover, housing portions 44 that are recessed toward a side of an outer circumferential surface 24D of the guide portion 24 and are able to house the supporting portions 38 are formed in portions at the inner circumferential surface portion 24B of the end portion 24C of the guide portion 24. A pair of anchor portions (not shown in the drawings) that are capable of anchoring the two end portions 42A of the shaft portion 42 are formed in portions on the second side in the thickness direction (i.e., on the inner side in the vehicle width direction) of the housing portions 44.

In addition, as a result of the two end portions 42A of the shaft portion 42 being anchored to the anchor portions of the housing portions 44, the supporting portions 38 are attached to the guide portion 24 as to be able to move rotationally. When viewed in the longitudinal direction of the shaft portion 42, when the supporting portions 38 are arranged such that the longitudinal direction of the supporting portions 38 extends in the radial direction of the guide portion 24, the corner portions 38A1 are positioned on the second side in the thickness direction (i.e., on the inner side in the vehicle width direction) and, in this state, rotational movement of the supporting portions 38 towards the second side in the thickness direction is restricted. On the other hand, in a case in which the supporting portions 38 are moved rotationally towards the first side in the thickness direction (i.e., towards the outer side in the vehicle width direction), then the entire supporting portions 38 are housed within the housing portions 44.

The torsion coil spring 40 is provided with a coil portion 40A and arm portions 40B, 40C, and the coil portion 40A is housed within a recessed portion (not shown in the drawings) provided in the supporting portions 38. The shaft portion 42 is inserted through the coil portion 40A. The arm portion 40B is fitted inside a groove portion (not shown in the drawings) provided in the supporting portions 38, while the arm portion 40C abuts against a surface located at a side of the outer circumferential surface portion 24D of the housing portions 44. As a result, the supporting portion 38 is in a state of being urged by the torsion coil spring 40 so as to move rotationally towards the second side in the thickness direction (i.e., towards the inner side in the vehicle width direction).

In the restricting portion 30 formed in the above-described manner, when a pressing force F, which is applied at the other end portion 26B of the breaking portion 26 via the base plate portion 28 by a vehicle occupant, from the side of the other end portion 26B towards the side of the door glass 20 is a predetermined magnitude or greater, displacement of the breaking portion 26 towards the side of the door glass 20 is permitted. In contrast, if the pressing force F is less than the predetermined magnitude, then displacement of the breaking portion 26 towards the side of the door glass 20 is restricted.

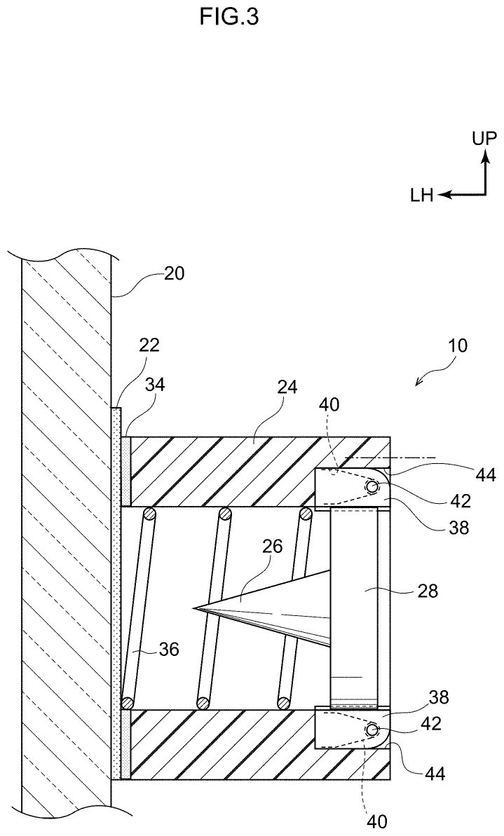

Moreover, because the supporting portions 38 are formed having the above-described structure, as is shown in FIG. 3, the supporting portions 38 can be moved rotationally by a pressing force from the second side in the thickness direction, and housed within the housing portions 44. Because of this, when the breaking device 10 is assembled, after the guide portion 24 at which the supporting portions 38 have already been mounted is attached to the glass door 20, the cylindrical coil spring 36 and a sub-assembly that is formed by the breaking portion 26 and the base plate portion 28 can be assembled inside the guide portion 24.

The cover portion 32 is formed having a circular plate shape whose outer diameter, when viewed in the thickness direction, is set as approximately the same as the outer diameter of the guide portion 24. The cover portion 32 is axially supported at the end portion 24C of the guide portion 24 by a pin 46 so as to be able to move rotationally around the thickness direction. As a result of the cover portion 32 being moved rotationally, the end portion 24C of the guide portion 24 is opened or closed.

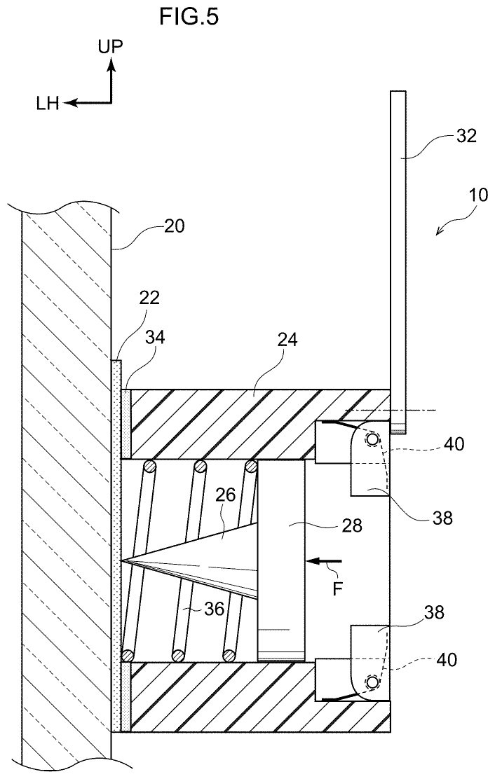

In the breaking device 10 having the above-described structure, as is shown in FIG. 5, in an emergency, after the cover portion 32 has been moved rotationally so as to open up the end portion 24C of the guide portion 24, in the event that a vehicle occupant then presses the base plate portion 28 towards the side of the door glass 20, the door glass 20 can be broken.

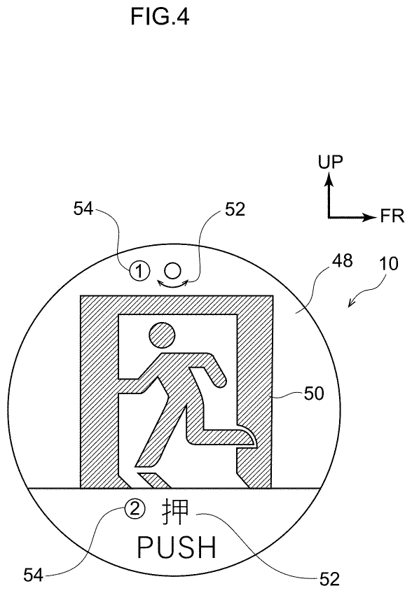

Moreover, as is shown in FIG. 4, a sticker 48 that shows both how to operate the breaking device 10 and also that the door glass also functions as an emergency exit is adhered to the surface located on the second side in the thickness direction of the cover portion 32.

More specifically, a pictogram 50 showing an emergency exit as stipulated by ISO 7010, symbols 52 showing how to operate the breaking device 10, and symbols 54 showing the operating sequence of the breaking device 10 are printed on the sticker 48. As a consequence, a vehicle occupant is able to understand intuitively how to operate the breaking device 10. Note that it is also possible for Braille characters showing the above-described contents to be imprinted on the sticker 48.

### Actions and Effects of the Present Exemplary Embodiment

Next, actions and effects of the present exemplary embodiment will be described.

As is shown in FIG. 1, the breaking device 10 is provided with the breaking portion 26 having the pointed one end portion 26A. The breaking portion 26 is disposed so that the one end portion 26A points towards the inner surface 20A at the vehicle inner side of the door glass 20 that is made from tempered glass. Because of this, in an emergency, by moving the breaking portion 26 towards the door glass 20 and causing the one end portion 26A to pierce the door glass 20, it is possible to break the door glass 20.

In the event that a structure in which the direction of input of the operating force when a vehicle occupant operates the breaking portion 26 is the reverse direction from the direction in which the breaking portion 26 pierces the door glass 20, the transmission path of the operating force may become more complex before the operating force is transmitted to the door glass 20.

In the present exemplary embodiment, both the guide portion 24 and the restricting portion 30 are provided, and the guide portion 24 is disposed at the side of the inner surface 20A of the door glass 20 and is able to guide the breaking portion 26 in the thickness direction. The restricting portion 30 permits displacement of the breaking portion 26 towards the door glass 20 when the pressing force F, which is applied at the other end portion 26B of the breaking portion 26 from the side of the other end portion 26B towards the side of the door glass 20 by a vehicle occupant, is a predetermined magnitude or greater.

For this reason, as is shown in FIG. 5, in an emergency, by pressing the breaking portion 26 from the side of the other end portion 26B using a pressing force F that is equal to or greater than the predetermined magnitude, a vehicle occupant is able to cause the breaking portion 26 to be moved towards the door glass 20, and to consequently cause the breaking portion 26 to pierce the door glass 20. The direction of input of the operating force is the same direction as the direction in which the breaking portion 26 pierces the door glass 20, and it is possible to simplify the transmission path of this operating force while the operating force is transmitted to the door glass 20.

In a case in which the pressing force F is less than the predetermined magnitude, the restricting portion 30 restricts movement of the breaking portion 26 towards the door glass 20. Because of this, when there is no emergency, it is possible to prevent the breaking portion 26 from being displaced towards the door glass 20 due to a miss-operation performed by a vehicle occupant. Accordingly, in the present exemplary embodiment, in an emergency, input from a vehicle occupant is transmitted directly to door glass 20 so as to ensure the probability that the door glass 20 will be broken.

Moreover, the breaking portion 26 is formed from metal. Accordingly, when the one end portion 26A of this breaking portion 26 comes into contact with the door glass 20, it is possible to inhibit the one end portion 26A from being deformed and to thereby inhibit the pressing force F applied to the breaking portion 26 from being absorbed by this deformation.

Furthermore, the base plate portion 28 that is formed as a separate body from the breaking portion 26 is provided at the other end portion 26B of the breaking portion 26, and a vehicle occupant presses the breaking portion 26 towards the door glass 20 via the base plate portion 28. Because the base plate portion 28 is formed in a plate shape that covers the other end portion 26B when viewed in the thickness direction, compared with a structure in which a vehicle occupant directly presses the breaking portion 26, it is possible to secure a wider surface area available for a vehicle occupant to press. Accordingly, breaking operation of the glass door 20 can be performed well by a vehicle occupant.

Moreover, the restricting portion 30 is provided with the cylindrical coil spring 36 and the supporting portions 38. The cylindrical coil spring 36 urges the base plate portion 28 with a load of a predetermined magnitude from a side of the one end portion 26A towards the side of the other end portion 26B of the breaking portion 26. The supporting portions 38 are provided at the guide portion 24 and are able to support the base plate portion 28 when the base plate portion 28 is being urged by the cylindrical coil spring 36.

Because of this, when a vehicle occupant is not pressing the base plate portion 28, the base plate portion 28 is pressed against the supporting portions 38 by the cylindrical coil spring 36, and is placed in a state in which displacement of the base plate portion 28 is restricted.

In contrast, when the base plate portion 28 is being pressed by a vehicle occupant towards the door glass 20 at a pressing force F of a predetermined magnitude or greater, although the base plate portion 20 is displaced towards a side of the door glass 20, once the base plate portion 28 stops being pressed by the vehicle occupant, the base plate portion 28 is displaced towards a side of the supporting portion 38 by urging force from the cylindrical coil spring 36. As a result, the breaking portion 26 can be pressed repeatedly against the door glass 20. Accordingly, in an emergency, it is possible to increase the probability that the door glass 20 will be broken.

Moreover, the guide portion 24 is formed in the shape of a cylinder, and the breaking portion 26 is housed inside the guide portion 24. In addition, an end portion 24C of the guide portion 24 which is located at the opposite side thereof from the side of the door glass 20 can be opened or closed by the cover portion 32. Because of this, at normal times, an operation of the breaking portion 26 by a vehicle occupant can be inhibited, and in an emergency, the vehicle occupant is able to release the state in which the guide portion 24 is closed by the cover portion 32 and the breaking portion 26 is able to be operated by the vehicle occupant. Accordingly, it is possible to inhibit the breaking device 10 from being operated in error by a vehicle occupant.

Moreover, the guide portion 24 is joined via a join portion in the form of an adhesive agent to the door glass inner surface.

It should be noted that if no component that is able to cover the join portion 34 from the vehicle outer side of the join portion 34 is provided, then it is difficult to secure an attractive appearance when the periphery of the guide portion 34 is viewed from outside the vehicle. Moreover, if sunlight transmitted through the door glass 20 strikes the join portion 34, there is a possibility of the join portion 34 deteriorating. Forming a coating film using paint between the join portion 34 and the door glass 20 may be considered in order to prevent the deterioration of the join portion 34, however, if the adhesion between this coating film and the door glass 20 is inadequate, there is a possibility that a portion of this coating film that is in contact with the join portion 34 may be peeled away from the door glass 20 due to external force acting on the guide portion 24.

In the present exemplary embodiment, a coating portion 22 in the form of a ceramic print is interposed between the join portion 34 and the inner surface 20A of the door glass 20, and this coating portion 22 is disposed so as to cover the join portion 34 when viewed from the outside of the vehicle. Because of this, it is possible to conceal the join portion 34 using the coating portion 22 when the join portion 34 is viewed from outside the vehicle, and it is also possible to inhibit sunlight from directly striking the join portion 34.

Moreover, because the coating portion 22 is formed by performing a heat treatment on a ceramic coating material so as to bake this onto the door glass 20, even if external force is applied to the coating portion 22 from a side of the join portion 34, it is possible to inhibit the coating portion 22 from peeling away from the door glass 20. Accordingly, it is possible to inhibit the breaking device 10 from being deteriorated caused by sunlight and the coating film at the door glass 20 from peeling away because of external force while a pleasing external appearance of the vehicle 12 is ensured.

### Second Exemplary Embodiment

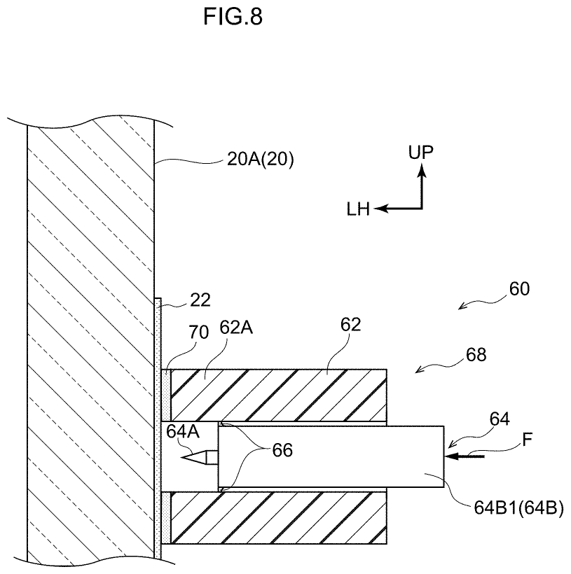

A vehicle door glass breaking device 60 (hereinafter, this will be abbreviated to a breaking device 60) according to a second exemplary embodiment of the present disclosure will now be described using FIG. 8. Note that component elements thereof that are the same as in the above-described first exemplary embodiment are given the same descriptive numbers and no description thereof is given.

In the present exemplary embodiment, the breaking device 60 is characterized in being provided with a breaking component 68 in which a guide portion 62, a breaking portion 64, and restricting portions 66 are integrally molded using a resin such as polycarbonate.

The guide portion 62 has basically the same structure as the guide portion 24. An end portion 62A at the first side in the thickness direction of the guide portion 62 is joined by a join portion 70 that is formed from a urethane-based adhesive agent to the inner surface 22A of the glass door 20 via the coating portion 22.

The breaking portion 64 is formed so as to include a cone-shaped one end portion 64A, and a circular-column shaped main body portion 64B that is provided at the second side in the thickness direction (i.e., on the inner side in the vehicle width direction) of the one end portion 64A. Note that the one end portion 64A of the breaking portion 64 and a portion at a side of the one end portion 64A of the main body portion 64B are housed inside the guide portion 62, while another end portion 64B1 of the main body portion 64B is positioned further to the second side in the thickness direction (i.e., further to the inner side in the vehicle width direction) of the guide portion 62 than an end surface on the second side in the thickness direction of the guide portion 62.

The restricting portions 66 are formed as protruding portions that protrude from a surface of the main body portion 64B towards the guide portion 62. A plurality of restricting portions 66 are arranged in a row in the circumferential direction of the main body portion 64B, and connect the breaking portion 64 to the guide portion 62. These restricting portions 66 are formed having a tapered shape such that a cross-section thereof becomes progressively smaller from the main body portion 64B as each of the restricting portions 66 approaches the guide portion 62. When the pressing force F applied to the other end portion 64B1 of the breaking portion 64 is equal to or greater than a predetermined size, the boundary portion between the main body portion 64B and the restricting portion 66 is broken.

In other words, when the pressing force F is equal to or greater than a predetermined magnitude, the restricting portion 66 permits displacement of the breaking portion 64 towards the glass door 20, and restricts this displacement of the breaking portion 64 towards the glass door 20 when the pressing force F is less than the predetermined magnitude.

Note that a sticker (not shown in the drawings) is adhered to the vicinity of the breaking component 68. In the same way as the sticker 48, a pictogram showing an emergency exit and a symbol showing how to operate the breaking device 60 are printed on this sticker. Note also that it is also possible for the breaking component 68 to be covered by a covering component such as a cover or the like that is joined by a join portion such as double-sided tape or the like to the door glass 20.

According to the above-described structure, in an emergency, by pressing the breaking portion 64 from a side of the other end portion 64B1 using a pressing force F that is equal to or greater than the predetermined magnitude, a vehicle occupant is able to cause the breaking portion 64 to move towards the door glass 20, and to cause the breaking portion 26 to pierce the door glass 20. Accordingly, in the present exemplary embodiment as well, fundamentally the same actions and effects as those demonstrated by the above-described first exemplary embodiment can be achieved.

Moreover, in the present exemplary embodiment, because the guide portion 62, the breaking portion 64, and the restricting portion 66 are formed as a single body, it is possible to simplify the component assembly process.

### Supplemental Description of the Above-Described Exemplary Embodiments

(1) In the above-described exemplary embodiments, the breaking devices 10 and 60 are provided at the door glass 20 of the sliding door 18, however, the present disclosure is not limited to this. For example, in a structure in which, in a side door that is provided with door glass and a window regulator, the door glass is housed in the side door internal portion except for in an upper edge portion thereof, then it is also possible to employ a structure in which the breaking devices 10 and 60 are provided in this upper edge portion.

(2) In the above-described first exemplary embodiment, the base plate portion 28 is urged by the cylindrical coil spring 36, however, the present disclosure is not limited to this. For example, instead of the cylindrical coil spring 36, it is also possible to use a plate spring or the like as the urging component depending on the shape and the like of the guide portion 24.

(3) Moreover, in the above-described first exemplary embodiment, the join portion 34 is only used for creating a joint with the guide portion 24, however, the present disclosure is not limited to this. For example, it is also possible to coat the adhesive agent forming the join portion 34 onto the inner side of the guide portion 24 in such a quantity that it protrudes therefrom, and to use this protruding adhesive agent as a protective film. Furthermore, by providing a protective sheet in those locations of the door glass 20 where it is intended that the breaking portion 26 will pierce, it is possible to prevent the door glass 20 from being broken by somebody accidentally operating the breaking portion 26.

(4) Furthermore, in the above-described first exemplary embodiment, a structure is employed in which the supporting portions 38 are able to move rotationally relative to the guide portion 24, however, the present disclosure is not limited to this. For example, instead of the supporting portions 38, it is also possible to use a C-ring that is anchored in a groove portion that is formed at the inner circumferential surface portion 24B of the guide portion 24 in accordance with the location and the like where the breaking device 10 is attached.

(5) In the above-described second exemplary embodiment, the one end portion 64A and the main body portion 64B are formed as a single body, however, the present disclosure is not limited to this. For example, it is also possible to form the one end portion 64A as a separate component that is made from metal depending on the type of resin that is used to form the main body portion 64B and the like.

Exemplary embodiments of the present disclosure have been described above, however, the present disclosure is not limited to these. Various modifications and the like may be made to the present disclosure insofar as they do not depart from the scope of the present disclosure.

What is claimed is:

1. A vehicle door glass breaking device, comprising:
a breaking portion including a pointed end portion that is configured to point towards a surface at a vehicle inner side of a door glass that is manufactured from tempered glass;
a guide portion configured to be disposed at the surface at the vehicle inner side of the door glass, and being configured to guide the breaking portion in a thickness direction of the door glass; and
a restricting portion configured, in a case in which a pressing force, applied by a vehicle occupant to another end portion of the breaking portion, at an opposite side of the breaking portion from the pointed end portion, in a direction from a side of the other end portion towards a side of the door glass, is equal to or greater than a predetermined magnitude, to permit displacement of the breaking portion towards the side of the door glass, and in a case in which the pressing force is smaller than the predetermined magnitude, to restrict displacement of the breaking portion towards the side of the door glass.

2. The vehicle door glass breaking device according to claim 1, wherein:
the breaking portion is formed from metal, and
the vehicle door glass breaking device further comprises a pressed portion, the pressed portion being provided at the other end portion of the breaking portion, and being formed in a plate shape so as to cover the other end portion of the breaking portion when viewed in the thickness direction of the door glass.

3. The vehicle door glass breaking device according to claim 2, wherein the restricting portion comprises:
an urging component that urges the pressed portion with a load of the predetermined magnitude from a side of the pointed end portion towards the side of the other end portion of the breaking portion; and
supporting portions that are provided at the guide portion, the supporting portions being configured to support the pressed portion in a case in which the pressed portion is urged by the urging component.

4. The vehicle door glass breaking device according to claim 1, wherein:
the guide portion is formed in a cylindrical shape, the guide portion being configured to accommodate the breaking portion inside the guide portion, and
the vehicle door glass breaking device further comprises a lid portion that is configured to open and close an end portion of the guide portion at an opposite side of the guide portion from the door glass.

5. The vehicle door glass breaking device according to claim 2, wherein:
the guide portion is formed in a cylindrical shape, the guide portion being configured to accommodate the breaking portion inside the guide portion, and
the vehicle door glass breaking device further comprises a lid portion that is configured to open and close an end portion of the guide portion at an opposite side of the guide portion from the door glass.

6. The vehicle door glass breaking device according to claim 3, wherein:
the guide portion is formed in a cylindrical shape, the guide portion being configured to accommodate the breaking portion inside the guide portion, and
the vehicle door glass breaking device further comprises a lid portion that is configured to open and close an end portion of the guide portion at an opposite side of the guide portion from the door glass.

7. The vehicle door glass breaking device according to claim 1, wherein the guide portion is joined by an adhesive agent to the inner surface of the door glass via a coating portion that is formed by a ceramic print and that is coated on the inner surface of the door glass, and
the coating portion covers a joint region between the guide portion and the door glass when viewed from a vehicle outer side.

8. The vehicle door glass breaking device according to claim 2, wherein the guide portion is joined by an adhesive agent to the inner surface of the door glass via a coating portion that is formed by a ceramic print and that is coated on the inner surface of the door glass, and
the coating portion covers a joint region between the guide portion and the door glass when viewed from a vehicle outer side.

9. The vehicle door glass breaking device according to claim 3, wherein the guide portion is joined by an adhesive agent to the inner surface of the door glass via a coating portion that is formed by a ceramic print and that is coated on the inner surface of the door glass, and
the coating portion covers a joint region between the guide portion and the door glass when viewed from a vehicle outer side.
